(19) United States
(12) Patent Application Publication
(10) Pub. No.: US 2013/0056993 A1
(43) Pub. Date: Mar. 7, 2013

(54) Use of thermal hydraulic DC generators meets the requirements to qualify as a "Green Energy" source

(71) Applicant: Eric William Newcomb, Harrison, ME (US)

(72) Inventor: Eric William Newcomb, Harrison, ME (US)

(21) Appl. No.: 13/134,343

(22) Filed: Sep. 7, 2011

(51) Int. Cl. H02K 7/18

(52) U.S. Cl. 290/1 R

(57) ABSTRACT

Thermal Hydraulic DC Generators capture energy from Turbine Generators, Combustion Engines, Geothermal Sources, Facility Systems, or Solar Collectors. These sources can be used to produce 180-degree Fahrenheit hot water in order to drive Thermal Hydraulic DC Generators. These Generators create a very efficient means of generating electric power.

Other co-generation systems require the use of steam to drive Steam Turbines. The use of steam as opposed to hot water requires more expensive equipment and more maintenance to operate than a 180 Degree F. hot water system. These 180 Degree F. hot water systems incorporating the Thermal Hydraulic DC Generators are more efficient than the Rankine Cycle or the Carnot Cycle.

Thermal Hydraulic DC Generator Engines incorporate a plc based control system that eliminates the need for governors and voltage regulators. They incorporate inverter systems to create “clean” power at unity power factor. This is a new system that has never been accomplished before.

### REFERENCES

### References Cited

### US Patent Documents

U.S. Pat. No. 5,899,067 May 1999 Hageman
U.S. Pat. No. 5,916,140 June 1999 Hageman
Rockwell Automation Publication 1769-IN070C-EN-P May 2008
Rockwell Automation Publication 1769-IN006B-EN-P
Rockwell Automation Publication 1769-1N062A-EN-P December 2001
Rockwell Automation Publication 1769-IN067B-EN-P September 2005
Rockwell Automation Publication 1769-IN065C-EN-P June 2010
Rockwell Automation Publication 1769-INO27A-EN-P February 2001
Rockwell Automation Publication 2711 P-IN002G-EN-P November 2009

### FIELD OF THE INVENTION

The technological innovation regarding the Thermal Hydraulic DC Generator revolves around regulating the flow of the hydraulic fluid to the hydraulic pump and creating the correct RPM for the DC Generator. The load demands of the building electrical system are matched through the plc based control system and instrumentation. The generator governor and regulator have been replaced by the plc based control system. The correct flow of hydraulic fluid is supplied to the hydraulic pump. The DC output from the generator is connected to an inverter that corrects the AC output to a unity power factor. This is a new system that has never been accomplished before.

### BACKGROUND OF THE INVENTION

### Step By Step Process Description:

Step 1. Natural Gas, Methane, #2 Fuel Oil, or Diesel Fuel can be used to power Turbine Generators or Combustion Engine Generators that produce electricity and synchronize with the utility electrical system by the use of an inverter at unity power factor.
Step 2. The exhaust from the Turbine Generators or Combustion Engine Generators Heat circulated water through manifolds or engine water jackets.
Step 3. Additional energy is recovered from the Turbine Generators or Combustion Engine Generators exhaust systems through the use of an air over water secondary heat exchanger that is incorporated with the same hot water closed loop system as the manifolds or the water jackets.
Step 4. Additional energy can be recovered from other building systems through the use of a water/steam over water secondary heat exchanger, Geothermal Sources, or Solar Collectors that are incorporated with the same hot water closed loop system as the Turbine Generators or Combustion Engine manifolds or water jackets.
Step 5. The temperature of the hot water closed loop system is regulated at 180 degrees F. by the use of variable frequency drive controlled circulating pumps. The temperature is a function of the water flow in the system. The flow of the water is regulated by the rpm of the circulating pumps. The vfd's are controlled by a plc based control system. PID loops in the plc program monitor and control the temperature, pressure, and flow of the hot water loop. These PID loops control the vfd output and the rpm of the circulating pumps. The heating water that returns from the Thermal Hydraulic DC Generator Engine is at approximately 150 degrees F.
Step 6. The 180-degree F. water is circulated through a Thermal Hydraulic DC

Generator Engine. The water is used to expand liquid carbon dioxide which in turn drives a piston in one direction. A solenoid valve that is controlled by the plc based control system controls the water flow. The liquid carbon dioxide does not experience a phase change. The Thermal Hydraulic DC Generator Engine does not involve an intake and exhaust cycle. It is very efficient and has a very long life expectancy with minimal maintenance requirements.
Step 7. An 80-degree F. cooling-water closed loop system is also required to operate the Thermal Hydraulic DC Generator Engine. This cooling-water loop is circulated through a sanitary water over water heat exchanger that is installed in the domestic water system or through a water over water heat exchanger that is connected to a cooling tower or a cooling water piping system in the ground. The domestic water temperature is usually around 70-80 Degrees F. The cooling water that returns from the Thermal Hydraulic DC Generator Engine is at approximately 100 degrees F.
Step 8. The temperature of the cooling water closed loop system is regulated by the use of variable frequency drive controlled circulating pumps. The temperature is a function of the water flow in the system. The flow of the water is regulated by the rpm of the circulating pumps. The vfd's are controlled by a plc based control system. PID loops in the plc program monitor and control the temperature, pressure, and flow of the hot water loop. These PID loops control the vfd output and the rpm of the circulating pumps. The heating water that returns from the Thermal Hydraulic DC Generator Engine is at approximately 170 degrees F.
Step 9. The 80-degree F. water is circulated through a Thermal Hydraulic DC Generator Engine. The water is used to contract liquid carbon dioxide, which in turn drives a piston in the opposite direction from expanded liquid carbon dioxide. A solenoid valve that is controlled by a plc based control system controls the water flow.
Step 10. The Thermal Hydraulic DC Generator Engine drives a hydraulic pump. The pistons moving back and forth pump hydraulic fluid. The flow of the hydraulic fluid is regulated by PID loops in the plc based control system. The plc program coordinates the opening and closing of the solenoid valves for the heating and cooling water loops with the required flow rate of the hydraulic fluid.
Step 11.The hydraulic pump drives a DC generator. The DC generator is connected to a grid tie inverter which synchronizes with the building electrical system at unity power factor. The term for this device is a “Thermal Hydraulic DC Generator”.

This is a new concept. It has never been accomplished before.
Step 12. Additional “Green Energy” systems can be connected to the same grid tie inverter in order to synchronize with the building electrical system. These systems can include solar photovoltaic modules and wind Turbine systems.

Step 13. Revenue metering is established to monitor the power sold to the utility when the total generation exceeds the demand for the building systems.
Step 14. In cases where revenue metering is not allowed by the utility, the number of

Micro Turbines that are synchronized to the building electrical system can be controlled by the plc based control system. In this case the demand for the building will have to exceed the total amount of power that is generated.

The PLC based control system will perform the following functions:
1. Regulate the temperatures, pressures and flow rates for the heating cycle and cooling cycle water system.
2. Regulate the temperatures, pressures and flow rates for the hydraulic systems.
3. Control the firing rate of the solenoid valves to regulate the engine speed.
4. Control the inverter output.
5. Control associated generation systems.
6. Monitor the electrical system load demand.
7. Communicate with multifunction relays associated with the utility service.
8. Data Collection System
9. Alarm system

The PLC based control system will utilizes the following devices:
1. 32 bit microprocessor
2. Analog Input Module
3. Analog Output Module
4. Discreet Input Module
5. Discreet Output Module
6. RTD Temperature Sensors
7. Differential Pressure Transmitters
8. Flow Meters
9. Variable Frequency Drives
10. Multifunction Protective Relays
11. Current Sensors
12. Voltage sensors
13. Frequency Sensors
14. Operator Interface Terminal
15. Data Collection System
16. Alarm System

### SUMMARY OF THE INVENTION

The use of the term “Thermal Hydraulic DC Generator”. This is a new term and it has never been incorporated before. I would like to patent this device. A person in the field would think that it would not be possible to use this combination of devices for the following reasons:
1. People in this field would not realize that the regulation of the hydraulic fluid in the Thermal Hydraulic DC Generator Engine to drive the Thermal Hydraulic DC Generator RPM at the correct speed could be achieved. This will eliminate the need for a regulator and a an engine speed governor that is typically required for an engine/generator package. This will require a plc based control system with the correct instrumentation devices.
2. People in this field would not realize that the regulation of the DC Generator and the output of the inverter to match the load demands could be achieved. This will require a plc based control system with the correct instrumentation devices.
3. People in this field would not realize that the regulation of pressures, temperatures, and flow rates for the closed loop hot water and cooling water systems could be achieved in a steady manner. This will require a plc based control system with the correct instrumentation devices.
4. People in this field would not realize that it is economically feasible to implement this system. The efficiency of the Thermal Hydraulic DC Generator is much better than anything else available for this type of application. This is new technology and people in the field are not aware of its capabilities.
5. People in this field would not realize that so much energy is wasted in turbine generator exhaust systems. They would not realize that so much energy can be recovered and used to generate additional electricity with a Thermal Hydraulic DC Generator at such a low cost. Again, this is new technology, and people in the field are not aware of its capabilities.
6. People in this field would not realize that the Thermal Hydraulic DC Generator system meets “Green Energy” requirements. “Green Energy” qualifies for tax credits and can add to the savings when this type of system is installed. Again, this is new technology, and people in the field are not aware of its capabilities.
7. People in this field would not realize that so much energy can be wasted from utility steam systems that enter large buildings in lots of cities around the world. They would not realize that so much energy can be recovered and used to generate additional electricity with a Thermal Hydraulic DC Generator at such a low cost. Again this is new technology, and people in the field are not aware of its capabilities.
8. People in this field would not realize that this system is very flexible and can incorporate other forms of Green Energy sources through the use of a common inverter.
9. People in this field would not realize that the use of the DC Generator and the inverter to generate electricity at unity power factor can increase the efficiency of the system.

### BRIEF DESCRIPTION OF THE DRAWINGS

FIG. 1 represents a flow diagram for a Thermal Hydraulic DC Generator connected to a microturbine system to capture waste heat from the exhaust and increase the efficiency of the overall system.

FIG. 2 represents a 32 bit microprocessor with Ethernet communications for the plc based control system.

FIG. 3 represents a discreet input module used for the plc based control system.

FIG. 4 represents a discreet output module for the plc based control system.

FIG. 5 represents an analog input module for the plc based control system.

FIG. 6 represents an analog output module for the plc based control system.

FIG. 7 represents an RTD input module for the plc based control system

FIG. 8 represents an operator interface terminal used for the plc based control system.

FIG. 9 represents a vfd used for circulation pump control with the plc based control system.

FIG. 10, A, B, C, D represents a grid tie inverter that will be used to convert DC power to

AC Power and synchronize with the utility power grid at unity power factor. A Process description is also included.

FIG. 11 represents a dc generator used to generate DC power.

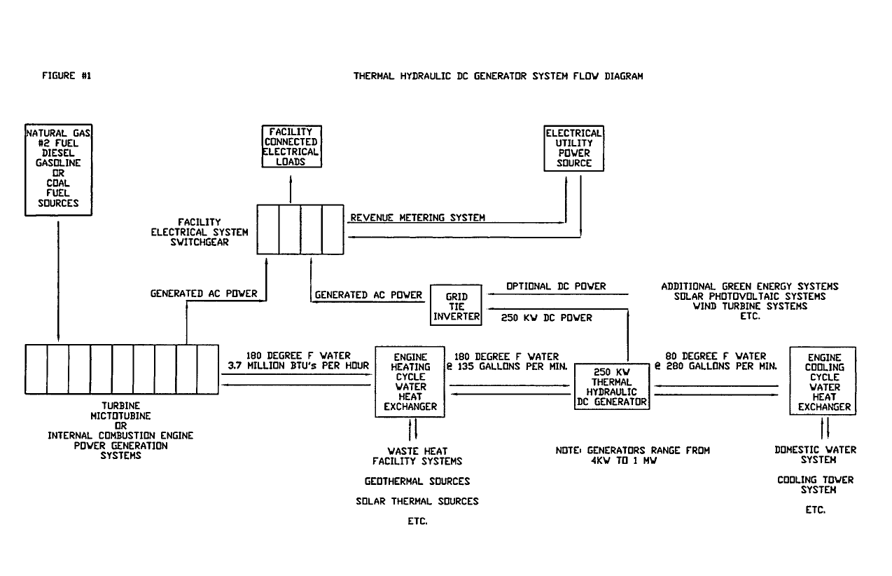

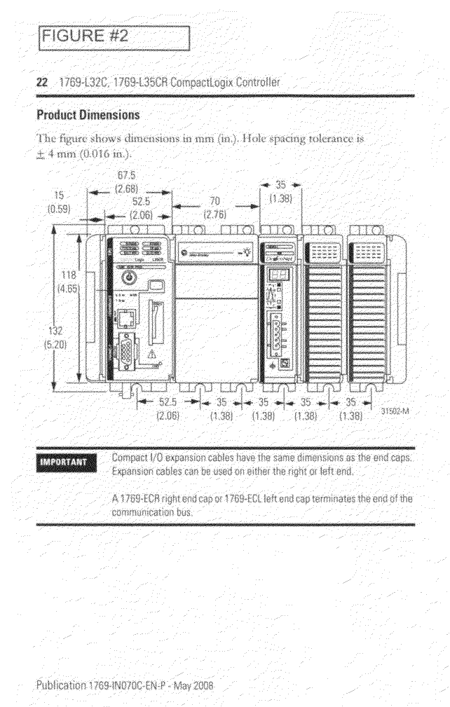

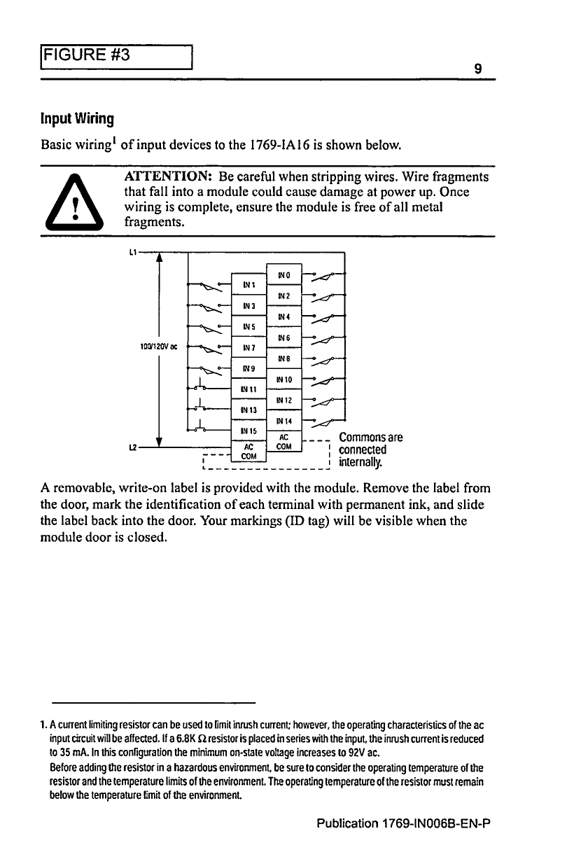

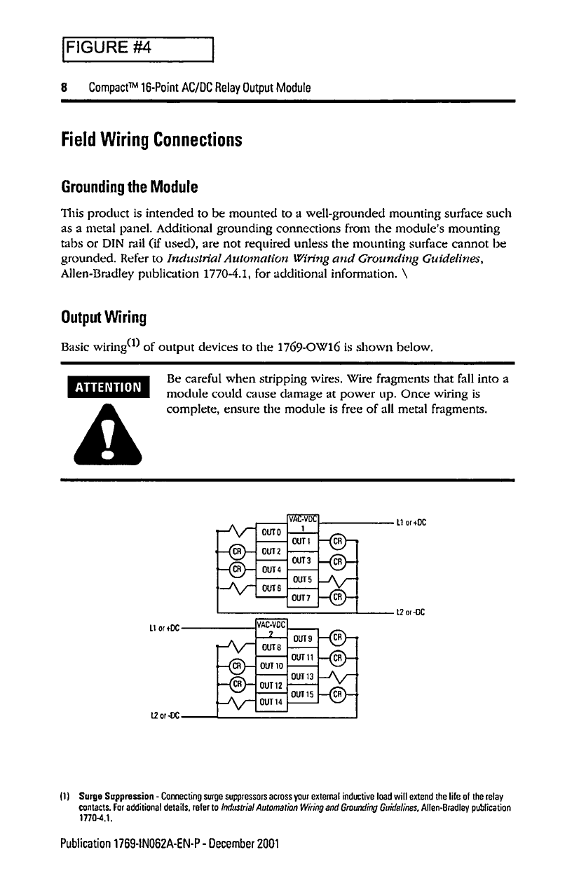

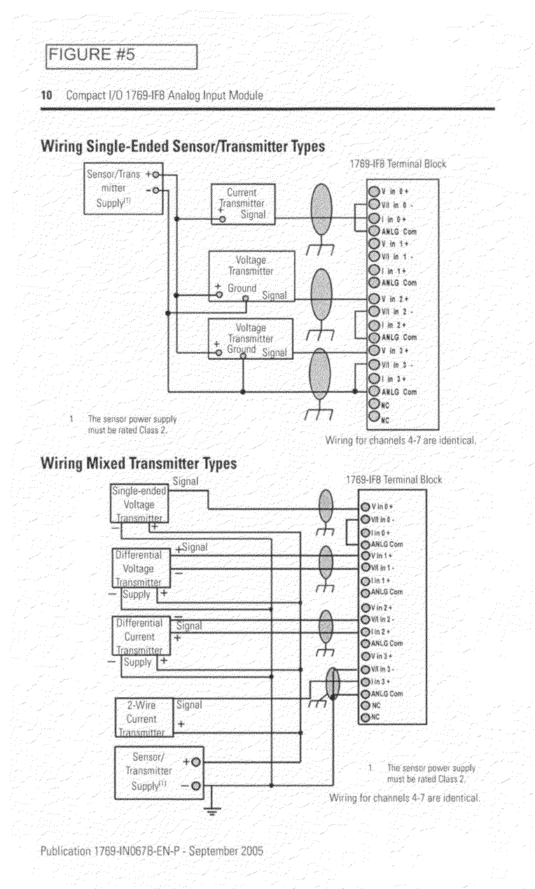

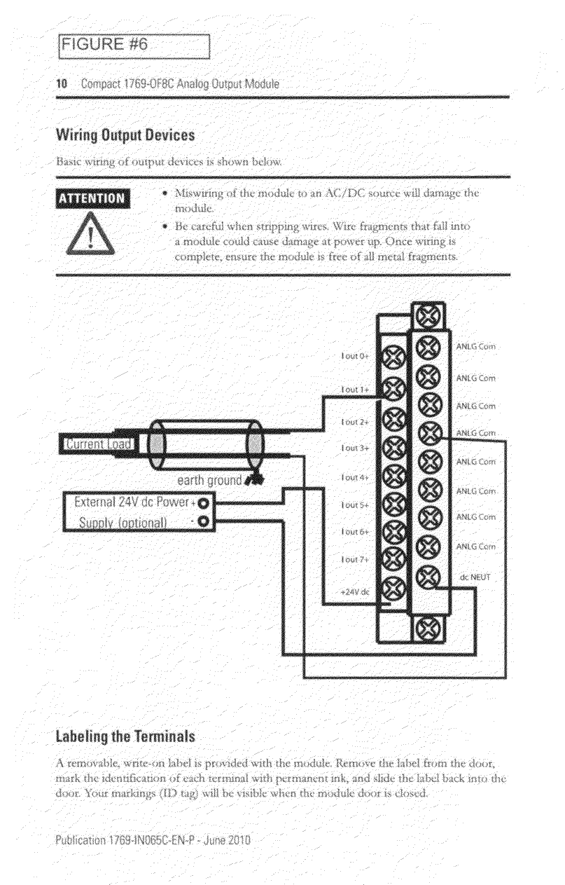

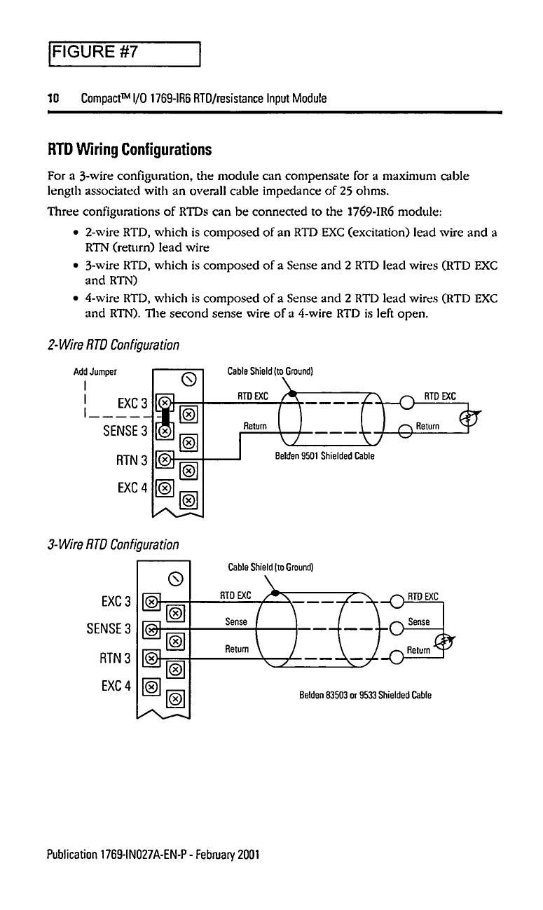

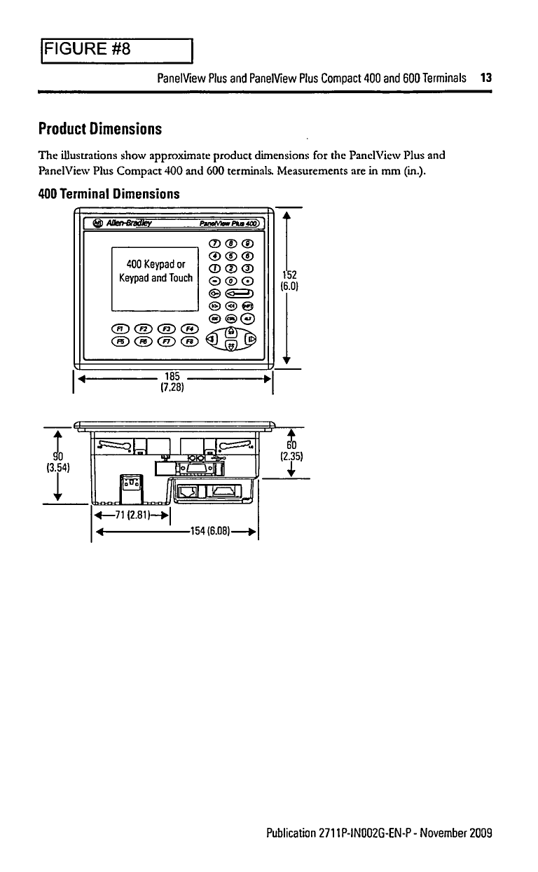

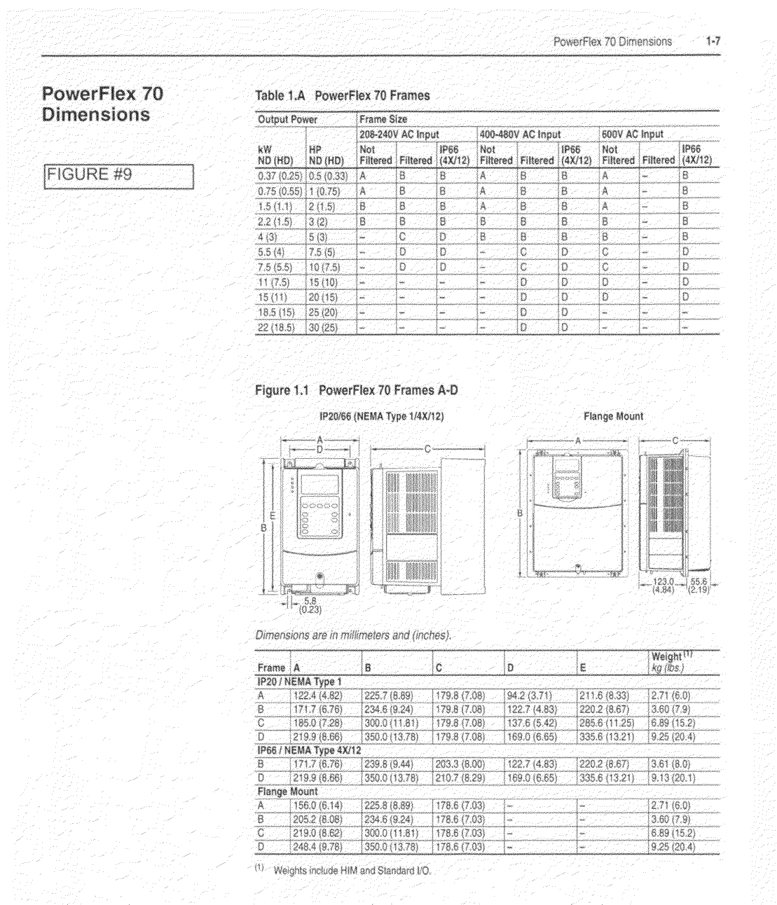

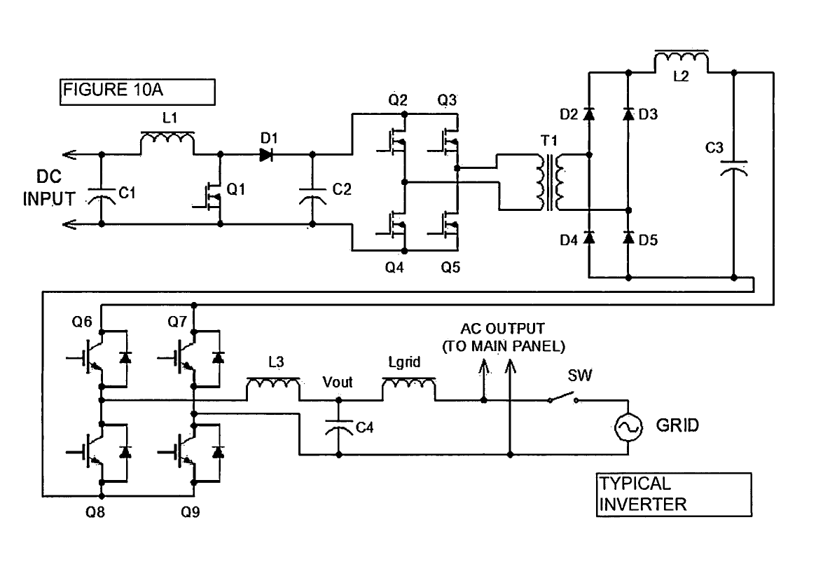

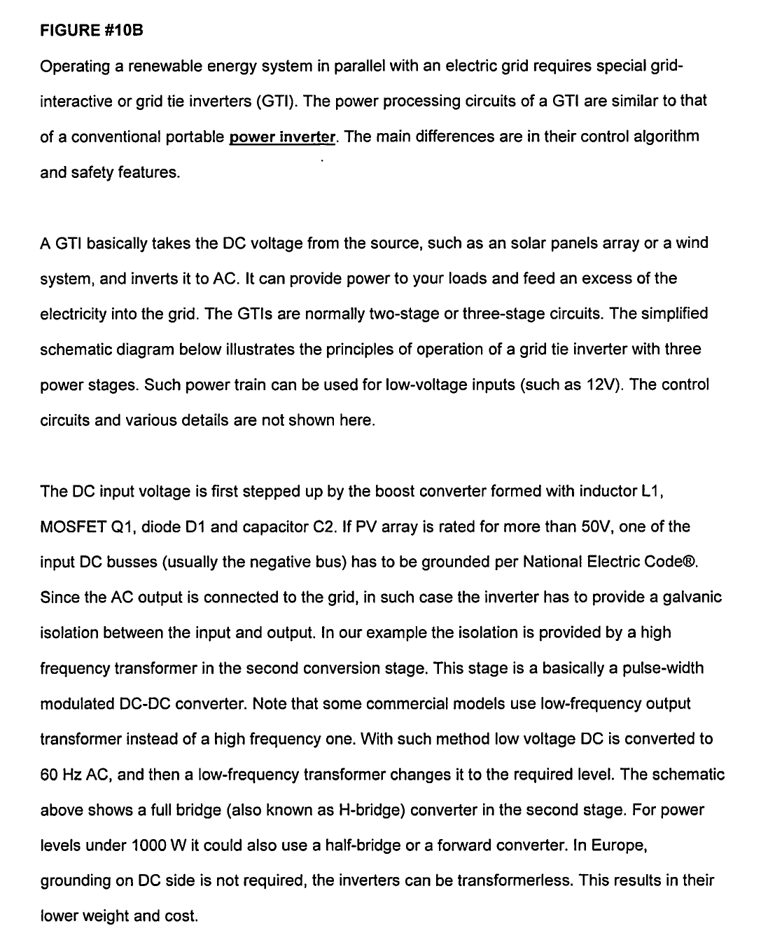

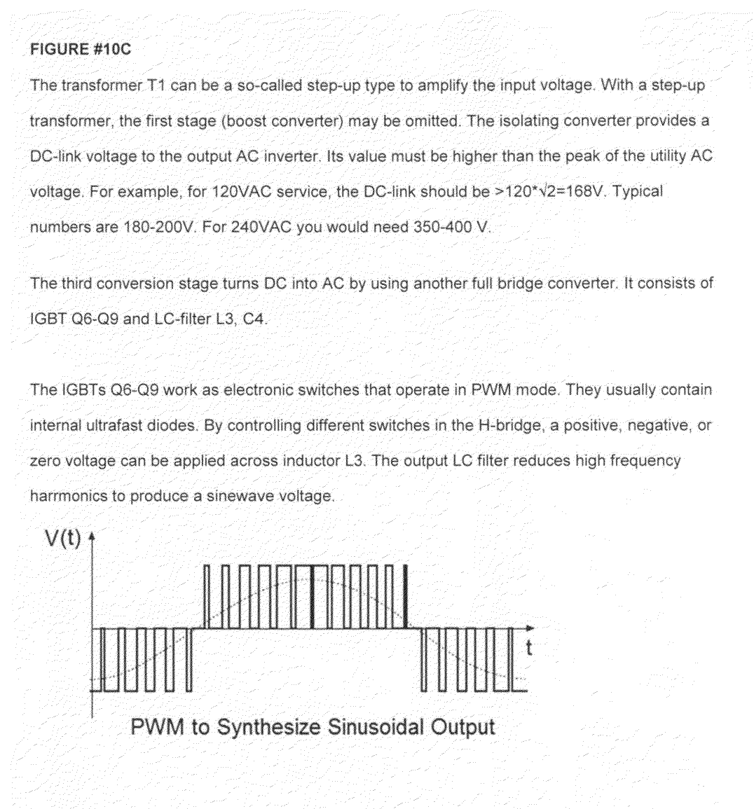

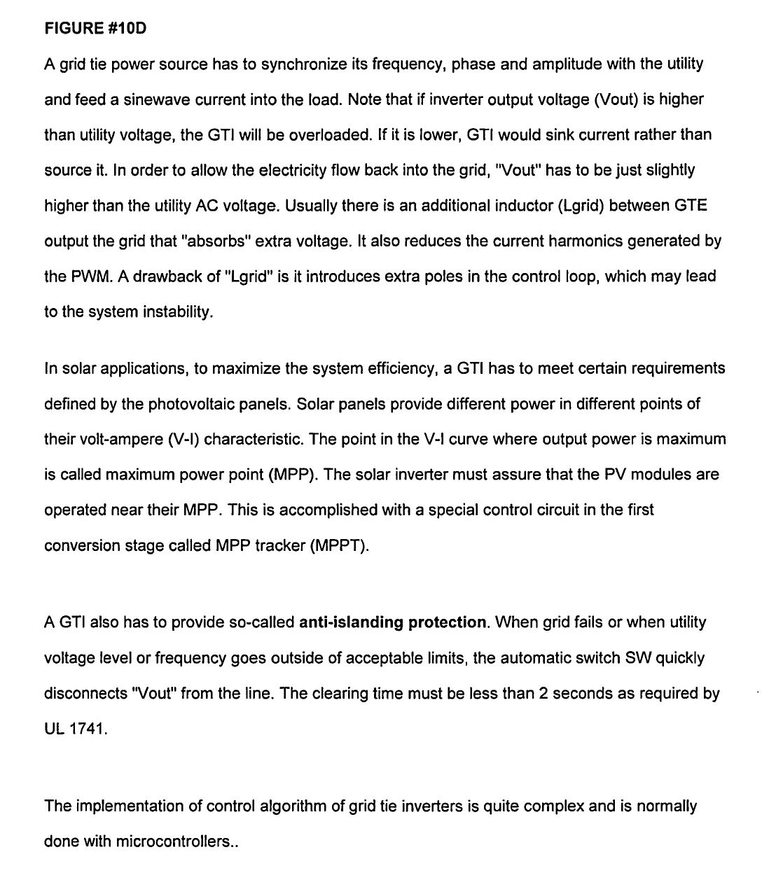

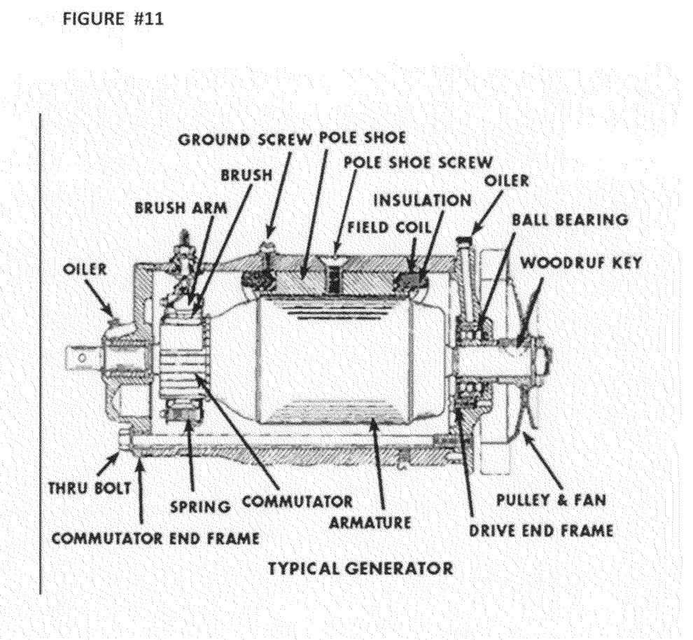

1. The method of claim 1, wherein:
The term “Thermal Hydraulic DC Generator” is incorporated.
This is a new term and it has never been incorporated before.

2. The method of claim 2, wherein:
Waste energy is recovered from Turbine Generator or Combustion Engine Generator Exhaust Systems to produce hot water for co-generation to drive Thermal Hydraulic DC Generators.

3. The method of claim 3, wherein:
Waste steam is recovered from utility systems to drive Thermal Hydraulic DC Generators.

4. The method of claim 4, wherein:
Energy from Combustion Engine Cooling Water Systems is recovered to produce hot water to drive Thermal Hydraulic DC Generators.

5. The method of claim 5, wherein:
The use of Solar Collectors is incorporated in conjunction with Thermal Hydraulic DC Generators. The Solar Collectors will produce hot water to drive the Thermal Hydraulic DC Generators.

6. The method of claim 6, wherein:
Incorporate the use of Geothermal Sources in conjunction with Thermal Hydraulic DC Generators. The Geothermal Sources will produce hot water to drive the thermal Hydraulic DC Generators
